(19) United States
(12) Patent Application Publication
(10) Pub. No.: US 2010/0089030 A1
(43) Pub. Date: Apr. 15, 2010

(54) CONTROLLING THE AERODYNAMIC DRAG OF A GAS TURBINE ENGINE DURING A SHUTDOWN STATE

(76) Inventor: Ray W. Carmichael, Ellington, CT (US)

Correspondence Address: CARLSON, GASKEY & OLDS/PRATT & WHITNEY, 400 WEST MAPLE ROAD, SUITE 350, BIRMINGHAM, MI, 48009, US

(21) Appl. No.: 12/440,647

(22) PCT Filed: Oct. 12, 2006
(86) PCT No.: PCT/US2006/039949

§ 371 Date: Dec. 9, 2009

(51) Int. Cl. F02K 3/02

(52) U.S. Cl. 60/226.3

(57) ABSTRACT

A gas turbine engine system includes a gas turbine engine (10) having aerodynamic drag that retards movement. The gas turbine engine has an active state and a shutdown state. A fan bypass passage (30) associated with the gas turbine engine conveys a bypass airflow (D) that influences the aerodynamic drag. A nozzle (40) associated with the fan bypass passage has a plurality of different positions that influences the bypass air flow to thereby influence the aerodynamic drag. The nozzle is operative to move between the plurality of different positions in response to the shutdown state to control the aerodynamic drag.

### BACKGROUND OF THE INVENTION

This invention relates to gas turbine engines and, more particularly, to a gas turbine engine having a variable fan nozzle that can be adjusted to change the aerodynamic drag of the engine.

Gas turbine engines are widely known and used for power generation and vehicle (e.g., aircraft) propulsion. A typical gas turbine engine includes a gas generator (compression section, a combustion section, and a turbine section) that utilizes a primary airflow into the gas generator to generate power or propel the vehicle. The gas turbine engine is typically mounted within a housing, such as a nacelle. A bypass airflow flows through a passage between the gas generator and the nacelle and exits from the engine at an outlet.

Presently, in the event that certain problems occur with one engine of a multi-engine aircraft, the engine can be shut down and the remaining engines can be used to fly the aircraft. For example, inclement weather, non-optimum trimming of engine idle, fuel nozzle coking, fuel contamination, loss of electric power, fuel mismanagement, pilot error, or the like may, under certain conditions, warrant voluntary or automatic shut down of an engine. Under such a circumstance, aerodynamic drag over the shutdown engine increases aircraft fuel consumption and retards thrust, which limits the range that the aircraft can travel to a destination airport. Although current engines permit a desirable range of travel under such circumstances, there is a trend toward improving the “one engine shutdown” performance to increase the range of travel and enhance maneuverability of the aircraft. This invention addresses this need.

### SUMMARY OF THE INVENTION

An example gas turbine engine system includes a gas turbine engine having aerodynamic drag that retards movement of the aircraft in flight. The gas turbine engine has an active state and a shutdown state, which is determined from rotor speed, fuel flow, or exhaust temperature, for example. A fan bypass passage associated with the gas turbine engine conveys a bypass airflow that influences the aerodynamic drag. A nozzle associated with the fan bypass passage has a plurality of different positions that influences the bypass air flow to thereby influence the aerodynamic drag. A controller commands the nozzle to move between the plurality of different positions in response to the shutdown state to control the aerodynamic drag.

### BRIEF DESCRIPTION OF THE DRAWINGS

The various features and advantages of this invention will become apparent to those skilled in the art from the following detailed description of the currently preferred embodiment. The drawings that accompany the detailed description can be briefly described as follows.

FIG. 1 is a schematic view of an example gas turbine engine having a nozzle for influencing a bypass airflow in response a shutdown state of the engine.

FIG. 2 is a schematic view of an example nozzle for influencing the bypass airflow.

### DETAILED DESCRIPTION OF THE PREFERRED EMBODIMENT

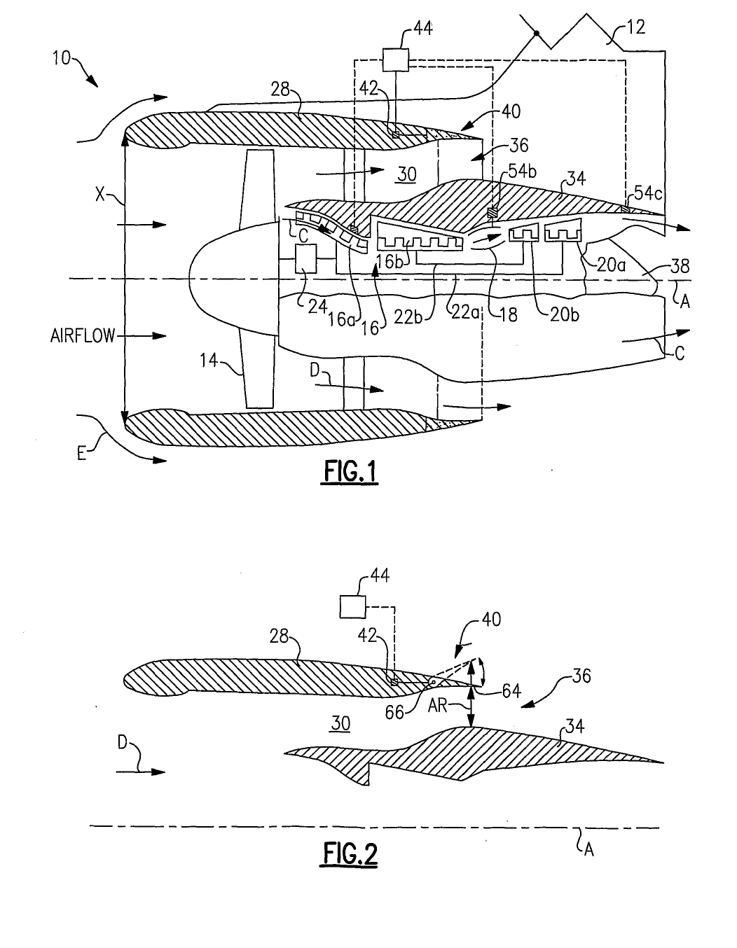

FIG. 1 illustrates a schematic view of selected portions of an example gas turbine engine 10 suspended from an engine pylon 12 of an aircraft, as is typical of an aircraft designed for subsonic operation. The gas turbine engine 10 is circumferentially disposed about an engine centerline, or axial centerline axis A. The gas turbine engine 10 includes a fan 14, a low pressure compressor 16a, a high pressure compressor 16b, a combustion section 18, a low pressure turbine 20a, and a high pressure turbine 20b. As is well known in the art, air compressed in the compressors 16a, 16b is mixed with fuel that is burned in the combustion section 18 and expanded in the turbines 20a and 20b. The turbines 20a and 20b are coupled for rotation with, respectively, rotors 22a and 22b (e.g., spools) to rotationally drive the compressors 16a, 16b and the fan 14 in response to the expansion. In this example, the rotor 22a also drives the fan 14 through a gear train 24.

In the example shown, the gas turbine engine 10 is a high bypass turbofan arrangement. In one example, the bypass ratio is greater than 10, and the fan 14 diameter is substantially larger than the diameter of the low pressure compressor 16a. The gear train 24 can be any known suitable gear system, such as a planetary gear system with orbiting planet gears, planetary system with non-orbiting planet gears, or other type of gear system. In the disclosed example, the gear train 24 has a constant gear ratio. Given this description, one of ordinary skill in the art will recognize that the above parameters are only exemplary and that other parameters may be used to meet the particular needs of an implementation.

An outer housing, nacelle 28, (also commonly referred to as a fan nacelle) extends circumferentially about the fan 14. A fan bypass passage 30 extends between the nacelle 28 and an inner housing, inner cowl 34, which generally surrounds the compressors 16a, 16b and turbines 20a, 20b.

In operation, the fan 14 draws air into the gas turbine engine 10 as a core flow, C, and into the bypass passage 30 as a bypass air flow, D. In one example, approximately 80 percent of the airflow entering the nacelle 28 becomes bypass airflow D. A rear exhaust 36 discharges the bypass air flow D from the gas turbine engine 10. The core flow C is discharged from a passage between the inner cowl 34 and a tail cone 38. A significant amount of thrust may be provided by the discharge flow due to the high bypass ratio.

The example gas turbine engine 10 shown FIG. 1 also includes a nozzle 40 (shown schematically) associated with the bypass passage 30. In this example, the nozzle 40 is shown near the rear of the nacelle 28, however, in other examples, the nozzle is located farther forward but aft of the fan 14. In this example, the nozzle 40 is coupled to the nacelle 28. Alternatively, the nozzle 40 is coupled with the inner cowl 34, or other structural portion of the gas turbine engine 10.

The nozzle 40 is operatively connected with actuators 42 for movement between a plurality of positions to influence the bypass air flow D, such as to manipulate an air pressure of the bypass air flow D. A controller 44 commands the actuators 42 to selectively move the nozzle 40 among the plurality of positions to manipulate the bypass air flow D in a desired manner. The controller 44 may be dedicated to controlling the actuators 42 and nozzle 40, integrated into an existing engine controller within the gas turbine engine 10, or be incorporated with other known aircraft or engine controls. For example, selective movement of the nozzle 40 varies the amount and direction of thrust provided, influences conditions for aircraft control, influences conditions for operation of the fan 14, or influences conditions for operation of other components associated with the bypass passage 30, depending on input parameters into the controller 44.

In one example, the gas turbine engine 10 is designed to operate within a desired performance envelope under certain predetermined conditions, such as cruise. For example, it is desirable to operate the fan 14 under a desired pressure ratio range (i.e., the ratio of air pressure aft of the fan 14 to air pressure forward of the fan 14) to maintain optimum fan efficiency. To maintain this range, the nozzle 40 is used to influence the bypass airflow D to control the air pressure aft of the fan 14 and thereby control the pressure ratio. In some examples, the nozzle varies a cross-sectional area associated with the rear exhaust 36 of the bypass passage 30 by approximately 20% to influence the bypass airflow D. Thus, the nozzle 40 enables the performance envelope to be maintained over a variety of different conditions.

In the illustrated example, the gas turbine engine 10 also includes one or more sensors 54a, 54b, 54c in communication with controller 44. Sensor 54a is located near rotor 22a for determining a rotational speed of the rotor 22 a. Sensor 54b is located near the combustor section 18 for determining an amount of fuel flow into the combustor section. Sensor 54c is located near the core flow C to determine a temperature of the core flow C.

The sensors 54a, 54b, 54c detect, respectively, the rotor speed, fuel flow, and core flow C (i.e., exhaust gas stream) temperature data and transmit a signal representative of the data to the controller 44. The controller 44 communicates with one, two, or all of the sensors 54a, 54b, 54c. The controller 44 selectively commands the actuators 42 to move the nozzle 40 to a predetermined desired position in response to a signal that represents a shutdown state of the engine. For example, the nozzle 40 moves from a nominal or scheduled position to the predetermined position.

In one example, the shutdown state corresponds to the rotor 22a rotational speed. For example, if the speed decreases below a threshold speed the controller 44 concludes that the gas turbine engine changed from an active state to the shutdown state.

In another example, the shutdown state corresponds to the fuel flow. For example, if the fuel flow decreases below a threshold fuel flow the controller 44 concludes that the gas turbine engine 10 changed from an active state to the shutdown state.

In another example, the shutdown state corresponds to the temperature of the core flow C. For example, if the temperature decreases below a threshold temperature the controller 44 concludes that the gas turbine engine 10 changed from an active state to the shutdown state.

Alternatively, or in addition any of the rotor speed, fuel flow, and temperature, the shutdown state corresponds to manual shutdown of the gas turbine engine 10 by the pilot in response to an indicator light, a perceived problem such as a decrease in thrust, or other indication to the pilot. Given this description, one of ordinary skill in the art will be able to recognize other characteristics of the gas turbine engine 10 that can be used to identify the shutdown state.

In response to the shutdown state, the controller 44 commands the actuators 42 to move the nozzle 40 to influence the bypass airflow D in a desired manner to decrease aerodynamic drag on the gas turbine engine 10. In this example, the aerodynamic drag includes at least the sum of aerodynamic drag on the outer surface of the nacelle 28, inlet momentum, and the internal aerodynamic drag on the engine 10 from the bypass airflow D and primary airflow C passing thru the engine turbomachinery.

Depending on factors such as a size characteristic of the nacelle 28, the controller 44 increases or decreases the bypass airflow D to reduce the overall aerodynamic drag. Reducing aerodynamic drag provides the benefit of less retarding force on the movement of the aircraft in flight, which increases fuel efficiency, increases the range of travel, and enhances maneuverability.

In one example, the bypass airflow D through the bypass passage 30 produces less aerodynamic drag than an airflow E over the nacelle 28. The controller 44 is programmed to command the nozzle 40 to permit more bypass airflow D through the bypass passage 30, which reduces the amount of airflow E over the nacelle 28 (e.g., spillage airflow). This provides the benefit of reducing the overall aerodynamic drag on the gas turbine engine 10.

In another example, the bypass airflow D through the bypass passage 30 produces more aerodynamic drag than the airflow E over the nacelle 28. The controller 44 is programmed to command the nozzle 40 to permit less bypass airflow D through the bypass passage 30, which increases the amount of airflow E over the nacelle 28 (e.g., from spillage airflow). This provides the benefit of reducing the overall aerodynamic drag on the gas turbine engine 10.

In one example, the aerodynamic drag produced from the bypass airflow D through the bypass passage 30 and the aerodynamic drag from the airflow E over the nacelle 28 is estimated at a design stage of the gas turbine engine 10 such that the controller 44 is pre-programmed to operate the nozzle 40 to reduce the aerodynamic drag. It is to be understood that the controller 44 may also use other factors, such as the instant flight conditions and type of aircraft, to control the nozzle 40 to selectively permit more or less bypass airflow D.

In one example, the overall aerodynamic drag corresponds to a size characteristic of the nacelle 28. For example, the nacelle 28 includes a nominal cross-sectional area, X, at the forward end that is selected during a design stage from among a range of possible cross-sectional areas for the particular engine 10. In this example, the aerodynamic drag from airflow E is larger than the aerodynamic drag from the bypass airflow D for a relatively small nominal cross-sectional area X. For a relatively larger nominal cross-sectional area X, the aerodynamic drag from airflow E is smaller than the aerodynamic drag from bypass airflow D. The controller 44 is then programmed based upon the size of the nacelle 28. For example, the controller 44 is programmed to permit more bypass airflow D for a nacelle 28 having the relatively smaller nominal cross-sectional area X or programmed to permit less bypass airflow D for a nacelle 28 having the relatively larger nominal cross-sectional area X.

FIG. 2 illustrates an example of the nozzle 40 for influencing the bypass airflow D. In this example, the nozzle 40 includes flaps 64 that are pivotable about hinges 66. Although only a single flap 64 and hinge 66 are shown in this figure, multiple flaps 64 may be used about the circumference of the engine 10. The hinges 66 are operatively connected with the actuators 42. The controller 44 selectively commands the actuators 42 to pivot the flaps 64 about the respective hinges 66 to vary a cross-sectional area, AR, between the flaps 64 and the inner cowl 34 in this example. In a closed position, the flaps 64 are closer to the inner cowl 34 for a relatively smaller cross-sectional area AR. In an open position, the flaps 64 are farther away from the inner cowl 34 for a relatively larger cross-sectional area AR.

The controller 44 selectively actuates the flaps 64 to control the air pressure of the bypass airflow D within the bypass passage 30. For example, closing the flaps 64 reduces the cross-sectional area AR, which restricts the bypass airflow D and produces a pressure build-up (i.e., an increase in air pressure) within the bypass passage 30. Opening the flaps 64 increases the cross-sectional area AR, which permits more bypass airflow D and reduces the pressure build-up (i.e., a decrease in air pressure). Given this description, one of ordinary skill in the art will be able to recognize other types of nozzles for influencing the bypass airflow D, such as, but not limited to auxiliary passage nozzles and bleed flow nozzles.

Although a preferred embodiment of this invention has been disclosed, a worker of ordinary skill in this art would recognize that certain modifications would come within the scope of this invention. For that reason, the following claims should be studied to determine the true scope and content of this invention.

We claim:

1. A gas turbine engine system comprising:
a gas turbine engine having aerodynamic drag that retards forward movement of the gas turbine engine in flight, the gas turbine engine having an active state and a shutdown state;
a fan bypass passage associated with the gas turbine engine for conveying a bypass airflow that influences the aerodynamic drag;
a nozzle associated with the fan bypass passage, the nozzle having a plurality of different positions that influences the bypass air flow to thereby influence the aerodynamic drag, wherein the nozzle is operative to move between the plurality of different positions in response to the shutdown state to control the aerodynamic drag.

2. The gas turbine engine system recited in claim 1, wherein the active state corresponds to a first fuel flow to the gas turbine engine and the shutdown state corresponds to a second fuel flow to the gas turbine engine that is less than the first fuel flow.

3. The gas turbine engine system recited in claim 1, wherein the gas turbine engine includes a compressor, a turbine downstream from the compressor, and at least one rotor that rotates with the compressor and the turbine, wherein the active state corresponds to a first rotational speed of the rotor and the shutdown state corresponds to a second rotational speed of the rotor that is less than the first rotational speed.

4. The gas turbine engine system recited in claim 1, wherein the gas turbine engine includes a combustor that combusts fuel to produce an exhaust gas stream, wherein the active state corresponds to a first temperature of the exhaust gas stream and the shutdown state corresponds to a second temperature of the exhaust gas stream that is less than the first temperature.

5. The gas turbine engine system recited in claim 1, wherein the gas turbine engine combusts fuel to produce a first thrust in the active state and the gas turbine engine produces a second thrust that is less than the first thrust in the shutdown state.

6. The gas turbine engine system recited in claim 1, further comprising a sensor that detects a fuel flow to the gas turbine engine, wherein the fuel flow corresponds to the shutdown state.

7. The gas turbine engine system recited in claim 1, further comprising a sensor that detects a rotational speed of a rotor associated with a turbine and a compressor in the gas turbine engine, wherein the rotational speed corresponds to the shutdown state.

8. The gas turbine engine system recited in claim 1, further comprising a sensor that detects a temperature of an exhaust gas stream produced by the gas turbine engine, wherein the temperature corresponds to the shutdown state.

9. The gas turbine engine system recited in claim 1, wherein the plurality of positions includes a first position that permits a first amount of the bypass airflow through the bypass passage and a second position that permits a second amount of the bypass airflow through the bypass passage that is less than the first amount of the bypass flow.

10. The gas turbine engine system recited in claim 9, wherein the gas turbine engine includes a nacelle that extends about at least a portion of the bypass passage, the nacelle including a forward opening having a selected predetermined cross-sectional area selected from a range of possible predetermined cross-sectional areas, wherein the controller selectively commands the nozzle to move to one of the first position or the second position based upon the selected predetermined cross-sectional area.

11. The gas turbine engine system recited in claim 1, wherein the nozzle comprises at least one flap adjacent the fan bypass passage and at least one actuator connected to the at least one flap to move the at least one flap between the plurality of positions.

12. A method of controlling a gas turbine engine having an active state and a shutdown state, comprising the steps of:
providing a nozzle that is associated with a fan bypass passage of the gas turbine engine to permit influence over a bypass airflow through the fan bypass passage; and
controlling the bypass airflow using the nozzle in response to the shutdown state to control an aerodynamic drag on the gas turbine engine.

13. The method recited in claim 12, including selectively moving the nozzle to one of a plurality of different positions to achieve an increase in the bypass airflow through the fan bypass passage and a decrease in an amount of airflow over a nacelle that extends about a fan of the gas turbine engine.

14. The method recited in claim 12, including selectively moving the nozzle to one of a plurality of different positions to achieve a decrease in the bypass airflow through the fan bypass passage and an increase in an amount of airflow over a nacelle that extends about a fan of the gas turbine engine.

15. The method recited in claim 12, including selecting between moving the nozzle to a first position that decreases the bypass airflow through the fan bypass passage and increases an amount of airflow over a nacelle that extends about a fan of the gas turbine engine and moving the nozzle to a second position that increases the bypass airflow through the fan bypass passage and decreases the amount of airflow over the nacelle based upon a size characteristic of the nacelle.

16. The method recited in claim 12, wherein the aerodynamic drag comprises the sum of at least an aerodynamic drag over a nacelle that extends about a fan of the gas turbine engine and an aerodynamic drag through the fan bypass passage, further including controlling the bypass airflow to decrease the aerodynamic drag.

17. The method recited in claim 12, including moving the nozzle to control the bypass airflow in response to a signal representing a fuel flow to the gas turbine engine.

18. The method recited in claim 12, including moving the nozzle to control the bypass airflow in response to a signal representing a rotational speed of a rotor associated with a compressor and a turbine within the gas turbine engine.

19. The method recited in claim 12, including moving the nozzle to control the bypass airflow in response to a signal representing a temperature of an exhaust gas stream produced by the gas turbine engine.
